(19) United States
(12) Patent Application Publication
(10) Pub. No.: US 2005/0128097 A1
(43) Pub. Date: Jun. 16, 2005

(54) Programmable multicandela notification device

(76) Inventors: Joseph Piccolo III, Fitzwilliam, NH (US); Juan A. Martinez, Watertown, MA (US); Gary W. Vincent, Lunenburg, MA (US)

Correspondence Address: IP LEGAL DEPARTMENT;TYCO FIRE & SECURITY SERVICES, ONE TOWN CENTER ROAD, BOCA RATON, FL, 33486, US

(21) Appl. No.: 10/872,852

(22) Filed: Jun. 21, 2004

Related U.S. Application Data
(60) Provisional application No. 60/528,952, filed on Dec. 11, 2003.

(51) Int. Cl. G08B 3/00

(52) U.S. Cl. 340/691.1; 340/531; 340/331; 340/506

(57) ABSTRACT

An alarm system notification device includes a strobe, a communication port, a manual selector that allows manual selection of strobe intensity, and a communication port through which the device transmits an indication of a selected strobe intensity. The device may also include a commandable selector that selects a strobe intensity in response to a command received from the communication port.

### RELATED APPLICATION(S)

This application claims the benefit of U.S. Provisional Application No. 60/528,952, filed Dec. 11, 2003. The entire teachings of the above application(s) are incorporated herein by reference.

### BACKGROUND

Fire alarm devices such as audible horns (audible/visible or A/V), loudspeakers (speaker/visible or S/V) and visible strobes (visible only or V/O), are referred to as “notification appliances.” Typically, a fire alarm control panel (FACP) drives these devices over one or more “notification appliance circuits” (NACs). The strobes are required, for example, as an alert for the hearing-impaired, or for those in a high noise environment.

A strobe is typically made up of a high-intensity Xenon flash tube, a reflector assembly, a transparent protective dome, an electronic control circuit, a terminal block to connect the device to the NAC and a housing to install the device to a wall or ceiling.

The strobe is a notification device designed to disperse its light output in a hemispherical pattern. The light distribution must meet stringent specification for UL approval, and it typically must accurately flash at a specified rate, for example, once per second or at some multiple. Strobes in the same viewing area typically must be synchronized, as a fast flash rate or several unsynchronized strobes at the normal rate could cause susceptible people to have epileptic seizures. See for example, U.S. Pat. No. 5,886,620, incorporated by reference herein in its entirety.

A manual selector, such as a moveable jumper, typically allows manual selection of strobe intensity, as well as a visual indication of the selection to a person who can clearly see the selector.

### SUMMARY OF THE INVENTION

It is desirable for fire alarm notification strobes to be able to output different intensities of light in different applications. For example a sleeping area requires a light intensity of at least 110 candela, while a small office may only require 15 candela. The different requirements for light output have traditionally been met by using different strobes in different areas or by using a strobe with a selectable output. Typically, on existing strobes with selectable intensity, a switch or jumper is used to manually select the appropriate candela setting. This leaves open the possibility of errors that may be difficult to detect during test and commissioning.

In accordance with an embodiment of the present invention, an alarm system notification device includes a strobe; a selector that allows manual selection of strobe intensity; and a communication port through which the device transmits an indication of a selected strobe intensity.

The communication port may be, but is not limited to, a wired, wireless, or optical connection. In an embodiment using a wired connection, the device transmits the selected or current strobe intensity information (indication) by superimposing the information over power lines.

In another embodiment, an alarm system notification device includes a strobe; and a communication port through which the device receives a command to select a strobe intensity. The device, in response to said command, configures itself to strobe at the selected intensity. A non-volatile memory can be used to store an indicator (such as the value itself, or some indication of the value) of the selected strobe intensity. Alternatively, a volatile memory could also be used.

In a further embodiment, the alarm system notification device includes an indicator that indicates to a person near the device the selected intensity. This can be a visual indicator, such as, for example, a LED that flashes according to the selected intensity, or a numeric display that indicates the selected intensity. Alternatively, the indicator can be an audible indicator.

In yet a further embodiment, the strobe device both receives intensity selection commands and reports current setting via a communication or network port.

An alarm system according to an embodiment of the present invention includes plural addressable alarm system notification devices, at least one notification device having a strobe and a selector which allows manual selection of strobe intensity; a control panel; and a communications channel through which the device transmits an indication of its respective selected strobe intensity to the control panel.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram illustrating a system embodying the present invention.

FIG. 2 is a schematic diagram of the system of FIG. 1, further illustrating details of an embodiment of the present invention.

### DETAILED DESCRIPTION

A description of preferred embodiments of the invention follows.

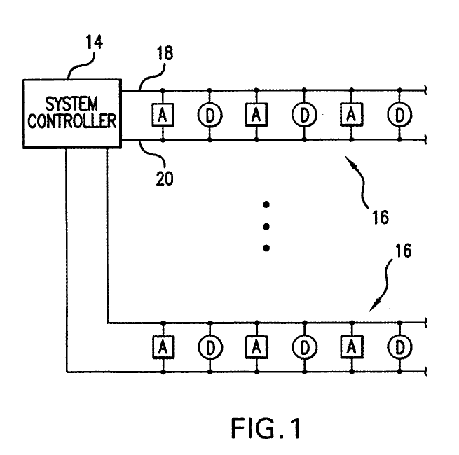

A system embodying the present invention is illustrated in FIG. 1. The system includes one or more notification appliance circuits (NACs), i.e., networks 16, having alarm condition detectors D and alarm notification appliances A. Alternatively, the detectors and notification appliances may be on separate networks. A system controller/FACP 14 monitors the detectors D. When an alarm condition is sensed, the system controller 14 signals the alarm to the appropriate notification appliances through one or more networks 16. Notification appliances may include, for example, a visual alarm (strobe), an audible alarm (horn), a speaker, or a combination thereof.

Although not necessary for carrying out the invention, as shown, all of the notification appliances in a network are coupled across a pair of power lines 18 and 20 that advantageously also carry communications between the system controller 14 and the detectors D and notification appliances A.

There are two main aspects to the present invention. The first is the ability to read a candela setting and report it to the fire alarm panel, confirming that each strobe is in fact programmed correctly. This may be used with strobes that have jumpers or switches to set their output. The second aspect is the ability to program the strobe via a command from the fire panel.

To program the strobes, the candela setting may be made via any means that changes the configuration setting for the device in the fire alarm panel, including, but not limited to: Software configuration tools; Fire alarm panel displays and keypads or similar user interfaces; Service port command; External computer interfaces; Internet interfaces; and Modem or other remote connection interfaces.

Once the candela setting for a device is configured in the fire alarm panel, the fire alarm panel communicates the selection to the device automatically and the device selects the configured setting for output.

This method eliminates the need to manually configure each device as it is installed. This has several advantages. For example, it allows changing or correcting candela setting without needing to access the device or replacing the device. Furthermore, labor may be reduced since need for jumper/switch setting may be eliminated. In addition, an embodiment of the invention may eliminate errors due to faulty manual configuration of a device since the intended candela setting may be set directly from a configuration established at the fire alarm panel.

In some embodiments, the device may be programmed with the candela setting via a command received from a control panel over a communications channel (digital or analog). The communication signal can, for example, be multiplexed onto the device's power line—this provides the added benefit that it saves the cost of additional wiring to devices. See for example, U.S. Pat. No. 6,426,697, incorporated by reference herein in its entirety. Alternatively, the communication line to the device may be separate from the power line. The communications channel may comprise, for example, a wireless link, a wired link or a fiber optic link.

Alternatively, or in addition, the device may be programmed manually (without its removal) via any of a variety of means, including but not limited to: optical signaling (e.g. TV remote control, blinking flashlight, light bulb or other light source, laser pointers, breaking optical beam), a magnet tapped against the device, radio frequency (RF) tags, sound signaling (e.g. ultrasonic tones, touchtones, clapping) etc.

The strobe selection data can be stored and/or updated in the device in a variety of ways. For example, in one embodiment, the intensity selection is stored in volatile memory. The device is updated from a fire alarm panel (control panel) each time the device is powered on. This saves the cost of using nonvolatile memory.

Alternatively, the intensity selection can be store in nonvolatile memory (retained when power lost). Nonvolatile memory includes, but is not limited to, FLASH memory, battery-backed RAM, battery backed electronic switches such as flip-flops or other switches, magnetic core memory, magnetic hard drives, optical media storage including but not limited to CD-ROM and DVD, and RF tags.

In other embodiments, the strobe intensity is updated continuously from the fire alarm panel whenever the device needs to strobe. In this embodiment, no memory may be required.

In some embodiments, the device reports the candela (intensity) setting to the fire alarm panel using a communication signal (digital or analog). This communication signal may be multiplexed onto the device's power line, or may be on a communication line that is separate from the power line. Alternatively, a fiber optic cable link or a wireless connection can be utilized.

Alternatively, or in addition, the device may directly report the candela setting, using for example, optical signaling (for example, an LED, an infrared emitter, a flashlight bulb or a mechanical shutter. The device may also report the setting using other means, such as RF tag reading or audio (e.g., ultrasonic, chirps, beeps, prerecorded or synthesized voice, etc.)

At least one embodiment combines, within a single device, communication to the fire alarm control panel 14 via a communication signal multiplexed onto device's power line, and an indicator at the device itself.

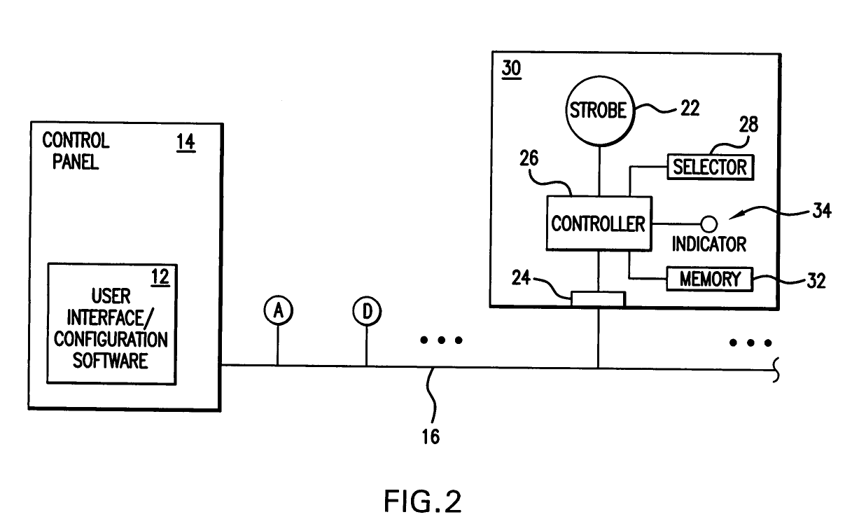

FIG. 2 is a schematic diagram of the system of FIG. 1, further illustrating details of an embodiment of the present invention. For simplicity, the two-line network of FIG. 1 is shown with a single line 16. The control panel 14 includes a user interface and configuration software 12 which allow a user to program candela settings for individual strobe devices 30 on the network or communications channel 16. The network 16 may include addressable detection devices D, as well as other notification devices or appliances A that may or may not include strobes. The control panel 14 may further be programmed to change the candela settings for one or more strobe devices 30 upon specific events or at certain times.

Strobe device 30 connects to the network 16 via a network interface (communication connection) 24. A controller 26, such as a microcontroller or hardwired logic, receives from and sends to the control panel 14 candela configuration data. When commanded, the strobe 22 flashes at the currently configured candela setting, which may be stored in a memory (volatile or non-volatile) 32. Although shown separately, the memory 32 may be integrated with the controller 26.

In some embodiments, a selector 28, such as a set of jumpers or a DIP switch, allows manual setting of the strobe intensity (candela setting). In at least one embodiment, this manual setting can be overwritten upon command from the control panel 14.

In some embodiments, an indicator 34, such as a flashing LED, indicates the currently configured candela setting, for example, upon command from the control panel 14, upon a local manual command such as a pushbutton (not shown), on a periodic basis, always, or upon some other event.

Although not shown, the strobe device 30 may also have an audible annunciator, such as a horn, bell or whistle, for audibly warning the public of a hazardous condition.

While the system has been particularly shown and described with references to particular embodiments, it will be understood by those of ordinary skill in the art that various changes in form and details may be made without departing from the scope of the invention. For example, the methods of the invention can be applied to various environments, and are not limited to the described environment.

1. An alarm system notification device comprising:
a strobe;
a selector which allows manual selection of strobe intensity; and
a communication port through which the device transmits an indication of a selected strobe intensity.

2. The alarm system notification device of claim 1, wherein the communication port utilizes a wireless connection.

3. The alarm system notification device of claim 1, wherein the communication port utilizes a wired connection.

4. The alarm system notification device of claim 3, the wired connection comprising power lines, the device transmitting the indication over the power lines.

5. The alarm system notification device of claim 1, wherein the communication port utilizes an optical connection.

6. An alarm system notification device comprising:
a strobe; and
a communication port through which the device receives a command to select a strobe intensity, the device in response to said command configuring itself to strobe at the selected intensity.

7. The alarm system notification device of claim 6, further comprising:
a non-volatile memory for storing an indicator of the selected strobe intensity.

8. The alarm system notification device of claim 6, further comprising:
a volatile memory for storing an indicator of the selected strobe intensity.

9. The alarm system notification device of claim 6, the command being received from a control panel.

10. The alarm system notification device of claim 6, further comprising:
an indicator that indicates to a person near the device the selected intensity.

11. The alarm system notification device of claim 10, the indicator being a visual indicator.

12. The alarm system notification device of claim 10, the indicator being a LED that flashes according to the selected intensity.

13. The alarm system notification device of claim 10, the indicator being a numeric display that indicates the selected intensity.

14. The alarm system notification device of claim 10, the indicator being an audible indicator.

15. The alarm system notification device of claim 6, the device transmitting through the communication port an indication of the selected strobe intensity.

16. The alarm system notification device of claim 6, further comprising:
a selector which allows manual selection of strobe intensity, the device transmitting through the communication port an indication of a selected strobe intensity.

17. An alarm system comprising:
plural addressable alarm system notification devices, at least one notification device having a strobe and a selector which allows manual selection of strobe intensity;
a control panel; and
a communications channel through which a strobe device transmits an indication of its respective selected strobe intensity to the control panel.

18. An alarm system comprising:
plural addressable alarm system notification devices, at least one notification device having a strobe;
a control panel; and
a communications channel through which the control panel commands a strobe device to select a strobe intensity.

19. An alarm system control panel comprising:
a user interface which allows a user to configure a strobe intensity for at least one notification device having a strobe; and
a communications channel through which the control panel transmits a strobe intensity command to said notification device.

20. An alarm system control panel comprising:
a communications channel through which the control panel receives, from at least one notification device having a strobe, an indication of a strobe intensity to which said device is currently set; and
an indicator which indicates, responsive to the received indication, the selected strobe intensity for said respective device.

21. A method for monitoring an alarm system notification strobe device, the method comprising, at the strobe device:
selecting one of a plurality of strobe intensities; and
transmitting, via a communication port, a message, the message comprising
an indication of a selected strobe intensity, and
an identifier of the strobe device.

22. The method of claim 21, wherein the step of selecting a strobe intensity is performed manually.

23. The method of claim 21, wherein the communication port utilizes a wired connection.

24. The method of claim 23, the wired connection comprising power lines, the strobe device transmitting the indication over the power lines.

25. A method for controlling an alarm system notification strobe device, the method comprising, at the strobe device:
receiving, via a communication port, a command to select one of a plurality of strobe intensities; and
responding to said command by selecting said intensity.

26. The method of claim 21, further comprising:
storing, in a non-volatile memory, an indicator of the selected strobe intensity.

27. The method of claim 21, further comprising:
indicating to a person near the device the selected intensity.

28. The method of claim 27, the indicator being a visual indicator.

29. The method of claim 21, further comprising:
transmitting, via the communication port, an indication of the selected strobe intensity.

30. An alarm system notification device comprising:
means for selecting one of a plurality of strobe intensities; and
means for transmitting a message, the message comprising
an indication of a selected strobe intensity, and
an identifier of the strobe device.

31. An alarm system notification device comprising:
means for reading a current strobe intensity setting;
means for transmitting a message, the message comprising:
an indication of the current strobe intensity setting; and
an identifier of the strobe device.
